(19) United States
(12) Patent Application Publication
(10) Pub. No.: US 2015/0207208 A1
(43) Pub. Date: Jul. 23, 2015

(54) ELECTRONIC DEVICE HOUSING AND METHOD FOR MAKING SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: XU LIU, Shenzhen (CN); YI YANG, Shenzhen (CN)

(21) Appl. No.: 14/527,311

(22) Filed: Oct. 29, 2014

(30) Foreign Application Priority Data
Jan. 22, 2014 (CN) 201410028762.2

(51) Int. Cl. H01Q 1/24; C23F 1/00

(52) U.S. Cl. CPC H01Q 1/243; C23F 1/00

(57) ABSTRACT

A housing includes main body having a support film and a base body integrated with the main body, the base body defines at least one through hole; an antenna includes at least one antenna body, and at least one connecting member is formed on an end of the antenna body, the connecting member is received in the through hole. A manufacture method of the housing and an electronic device using the housing are also provided.

### FIELD

The subject matter herein generally relates to a housing, an electronic device using the housing, and a method for making the housing.

### BACKGROUND

Antennas are important components in electronic devices such as mobile phones or personal digital assistants (PDAs).

### BRIEF DESCRIPTION OF THE DRAWINGS

Implementations of the present technology will now be described, by way of example only, with reference to the attached figures, wherein:

FIG. 1 is an isometric view of an electronic device according to an exemplary embodiment;

FIG. 2 is an exploded, isometric view of a housing of the electronic device shown in FIG. 1;

FIG. 3 an isometric view of a support film of the housing shown in FIG. 2; and

FIG. 4 is a cross-sectional view of the support film along line IV-IV of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

A definition that applies throughout this disclosure will now be present. The term “comprising,” when utilized, means “including, but not necessarily limited to”; it specifically indicates open-ended inclusion or membership in the so-described combination, group, series and the like.

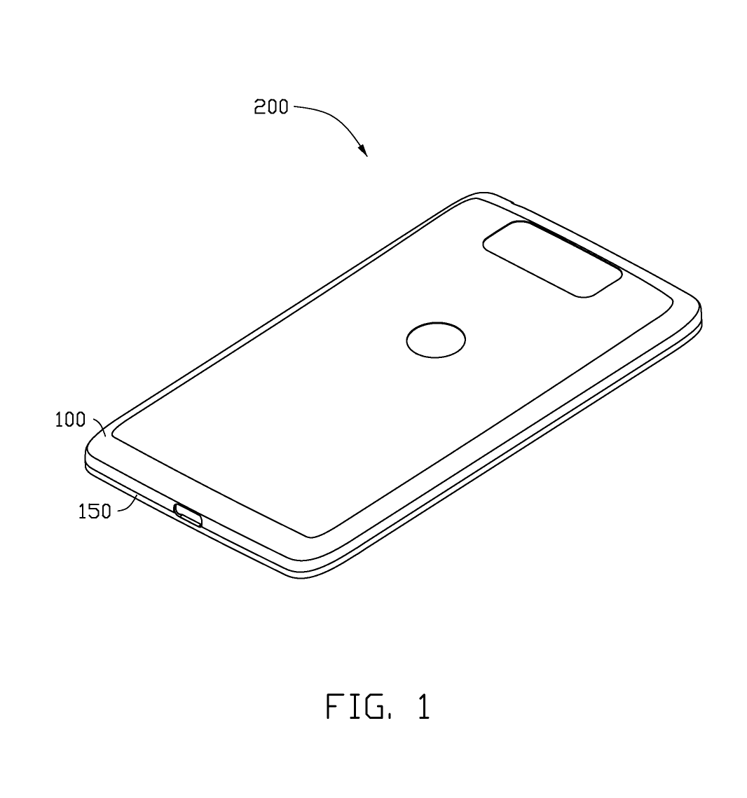

FIG. 1 illustrates an electronic device 200 according to an exemplary embodiment. The electronic device 200 can be, but not limit to, a mobile phone, or a personal digital assistant. The electronic device 200 includes a housing 100 and a main body 150. The housing 100 can be mounted on the main body 150.

The main body 150 includes a battery (not shown) and a circuit board (not shown) electronically connected with the battery. The circuit board defines a terminal (not shown), the terminal can be used to receive and send electromagnetic wave signals.

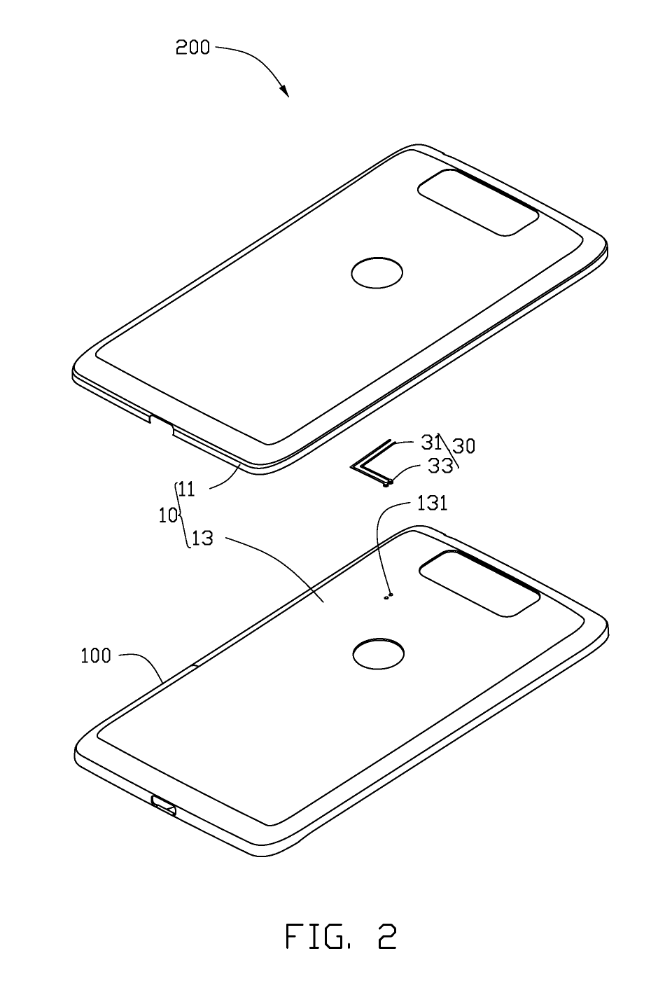

FIG. 2 illustrates the housing 100 further includes a housing body 10 and an antenna 30 mounted in the housing body 10. In one exemplary embodiment, the housing body 10 can be a back cover of the electronic device 200.

The housing body 10 includes a support film 11 and a base body 13 integrated with the support film 11. The base body 13 has the same shape and size as the support film 11. The combination of the base body 13 and the support film 11 can enhance the strength of the housing body 10.

The support film 11 can be made of plastic, such as polymethyl methacrylate(PMMA), or polyethylene terephthalate (PET). The thickness of the support film 11 is about 0.175 mm to about 0.5 mm. The base body 13 can be made of plastic, such as polymethyl methacrylate (PMMA), polycarbonate (PC), acrylonitrile butadiene styrene copolymers (ABS), or the composition of polycarbonate and acrylonitrile butadiene styrene copolymers (PC/ABS). The thickness of the base body 13 is about 0.6 mm to about 0.8 mm.

The base body 13 defines a plurality of through holes 131. In an exemplary embodiment, the number of the through holes 131 can be two. The location of the through holes 131 corresponds to the terminal of the circuit board.

The antenna 30 includes a plurality of antenna bodies 31 and a plurality of connecting members 33. Each of the connecting members 33 can be formed on one end of the corresponding antenna bodies 31. In an exemplary embodiment, the number of the antenna bodies 31 and the number of the connecting members 33 can be two. The antenna bodies 31 can be made of metal having good conductivity. In one exemplary embodiment, the antenna bodies 31 can be made of copper. The thickness of each antenna body 31 is about 12 um to about 15 um. The two connecting members 33 can be made of metal. In one exemplary embodiment, the connecting members 33 can be made of silver or copper. The diameter of the through holes 131 corresponds to the diameter of the connecting members 33, so the connecting members 33 can be received in the through holes 131, respectively, thereby the antenna 30 can be firmly mounted in the housing 100. In one exemplary embodiment, the connecting members 33 can partly extend out of the through holes 131 to electronically connect with the terminal, so the antenna 30 can be electronically connected with the circuit board.

The shape of the antenna 30 can be changed according to the demand of the electronic device 200. In one exemplary embodiment, the antenna 30 is L-shaped.

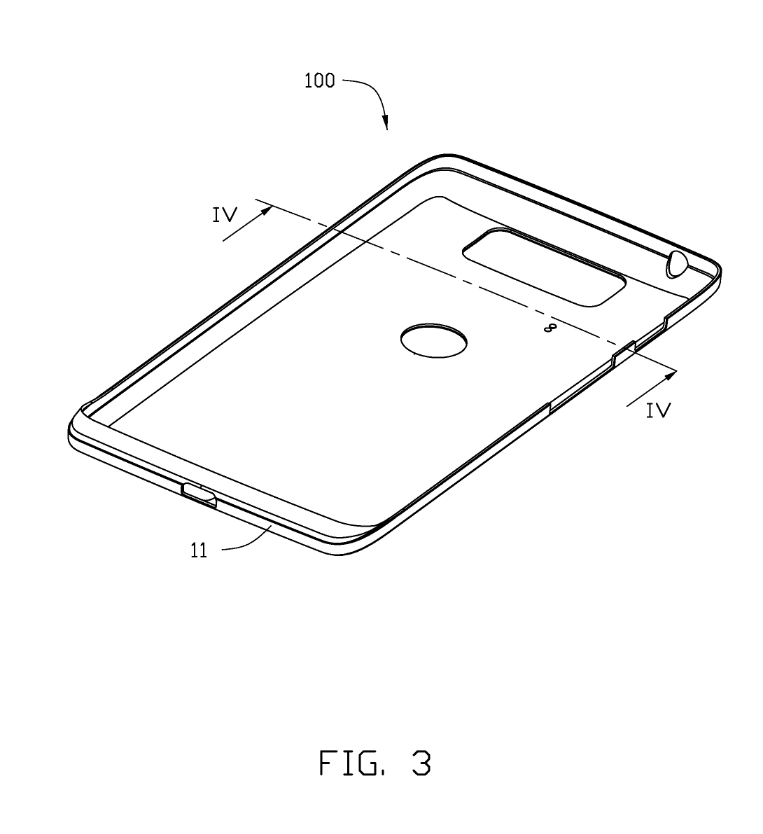

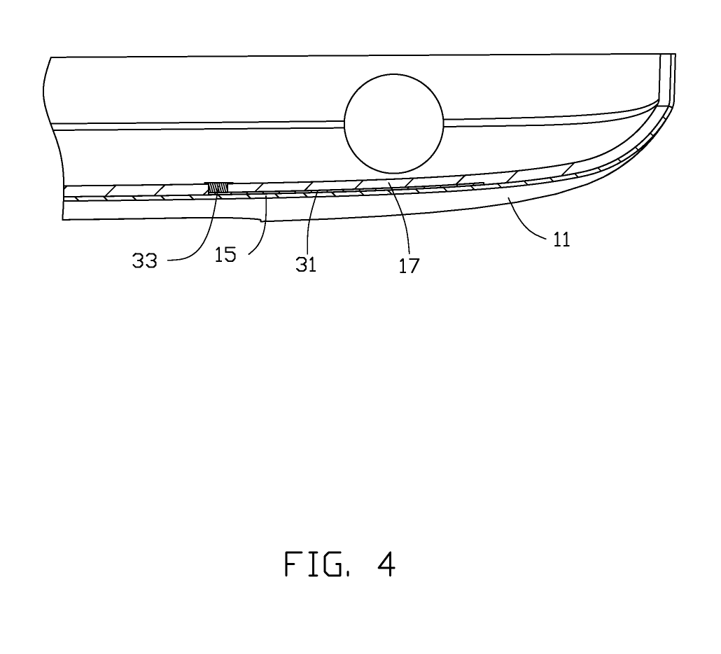

FIGS. 3-4 illustrate, the housing 100 further includes a base layer 15 formed on the support film 11, a shielding layer 17 formed on the antenna bodies 31. The antenna bodies 31 are sandwiched between the base layer 15 and the shield layer 17.

The base layer 15 is sandwiched between the support film 11 and the antenna bodies 31. The base layer 15 can be printed on the support film 11, and form a pattern. The base layer 15 can be made of ink. The thickness of the base layer 15 is about 12 um to about 15 um.

FIGS. 2 and 4 illustrate, the shield layer 17 can be formed by printing or spraying. In one exemplary embodiment, the shield layer 17 can be formed on the base layer 15 by spraying. The antenna bodies 31 can be covered by the shield layer 17. The connecting members 33 can pass through the shield layer 17, and then be received in the through holes 131.

An exemplary method for making the housing 100 can include the following steps.

A support film 11 is provided. A base layer 15 can be formed by printing ink on an internal surface of the support film 11. The printing method can be, but not limit to being, screen print, or ink jet printing. After printing, the ink is baked at an internal oven temperature between about 70 degrees Celsius (° C.) and about 75° C. from about 30 minutes to about 40 minutes. The base layer 15 can further form a pattern on the internal surface of the support film 11.

A plurality of metal layers (not shown) is formed on the base layer 15 by chemical plating, printing conductive ink, or attaching copper foil. In one exemplary embodiment, the metal layer can be made by chemical plating, and the number of the metal layers can be two. Then, sections of a portion of each metal layer are removed by chemical etching; the remaining sections of each of the metal layers form the antenna bodies 31. The shape of the antenna bodies 31 can be changed by the demand of the electronic device 200.

The shield layer 17 can be formed by spraying paint on the antenna bodies 31, then the paint is baked at an internal oven temperature of about 70° C. for about 30 minutes. The shield layer 17 covers the antenna bodies 31 to avoid damage to the antenna bodies 31. The shield layer 17 can also cover part of the support film 11.

The support film 11 is trimmed to remove the waste. Then the support film 11 is coated with the base layer 15, the antenna 30 and the shield layer 17 can be pressed into a three-dimensional shape required by the housing 100.

Plastic pellets are dried at temperature of 120° C. for about 5 hours. Then the support film 11 is coated with the base layer 15, the antenna 30 and the shield layer 17 are put into a mold (not shown), the mold has the same shape and size as the housing 100. Liquid plastic is injected into the mold, coating the shield layer and the part of the support film 11 exposed from the shield layer 17 by insert molding technology. The plastic composition is then dried to form the base body 13. The base body 13 defines two through holes 131.

An electrically-conductive slurry containing metal powder and resin is provided. The metal powder can be, for example, silver powder or copper powder. The metal powder has a mass percentage of about 85 percent to about 95 percent of the slurry. The resin can be, for example, acrylic resin having a mass percentage of about 5 percent to about 15 percent of the slurry.

A diluting agent is provided. The diluting agent contains cyclohexane having a mass percentage of about 70 percent to about 90 percent of the diluting agent, and butanone having a mass percentage of about 10 percent to about 30 percent of the diluting agent.

The diluting agent is added to the slurry; both the diluting agent and slurry are at about room temperature. The mass ratio between the diluting agent and the slurry is between about 1 to 19 and about 1 to 9.

The diluted slurry is then poured in the through holes 131 to fill the through holes 131. Once in the through holes 131 the diluted slurry is baked in an oven having an internal temperature of between about 100° C. and about 110° C. for about 45 minutes to about 60 minutes to remove the diluting agent and harden the slurry; thereby forming the connecting members 33. The connecting members 33 can be received in the through holes 131, and partly extend from the through holes 131. The terminal can be connected with the connecting members 33 exposed from the through holes 131; thereby electronically connecting the antenna 30 with the circuit board.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A housing comprising:
a housing body having a support film and a base body integrated with the support film, the base body defining at least one through hole;
an antenna comprising at least one antenna body, and at least one connecting member located on an end of the antenna body, the connecting member being received in the through hole.

2. The housing of claim 1, wherein the support film can be made of plastic, the thickness of the support film is about 0.175 mm to about 0.5 mm.

3. The housing of claim 1, wherein the body base can be made of plastic, the thickness of the base body is about 0.6 mm to about 0.8 mm.

4. The housing of claim 1, wherein the number of through hole and the number of the connecting member can be two, the diameter of the through holes corresponds to the diameter of the connecting members.

5. The housing of claim 4, wherein the connecting members can be made of one of silver and copper, the thickness of each of the connecting members is about 12 um to about 15 um.

6. The housing of claim 1, wherein the number of the antenna bodies can be two, the antenna bodies can be made of copper, and the thickness of each of the antenna bodies is about 12 um to about 15 um.

7. The housing of claim 4, wherein the housing further includes a base layer formed on the support film, and a shield layer formed on the antenna bodies, the antenna bodies are sandwiched between the base layer and the shield layer, the connecting members can passes through the shield layer, and then be received in the through holes.

8. The housing of claim 7, wherein the base layer can be made of ink, the shield layer can be made of painting, the thickness of the base layer and the thickness of the shield layer are about 12 um to about 15 um.

9. A method for making a housing, comprising:
forming at least one metal layer on a support film, sections of a portion of the metal layer are removed by the chemical etching, remaining sections of the metal layer forming at least one antenna body;
injecting molten plastic on the support film coated with the antenna body, and then cooling the molten plastic to form a base body, the base body defines at least one through hole;
filling the through hole with electrically-conductive slurry; and
baking the slurry in the through hole to form at least one connecting member.

10. The method as claimed in claim 9, wherein the slurry comprises metal powder and resin, the metal powder is silver powder or copper powder having a mass percentage of about 85 percent to about 95 percent of the slurry, the resin is acrylic resin having a mass percentage of about 5 percent to about 15 percent of the slurry.

11. The method as claimed in claim 9, further comprising a step of diluting the slurry using a diluting agent before the slurry is filled in the through hole, the mass ratio between the diluting agent and the slurry is about 1:19 and 1:9.

12. The method as claimed in claim 11, wherein the diluting agent comprises cyclohexane having a mass percentage of about 70 percent to about 90 percent, and butanone having a mass percentage of about 10 percent to about 30 percent.

13. The method as claimed in claim 11, wherein baking the slurry is carried out in an oven having an internal temperature of about 100° C. to about 110° C. for about 45 minutes to about 60 minutes to remove the diluting agent.

14. The method as claimed in claim 9, wherein further comprising a step of printing a base layer on a support film before the antenna body is formed on the support film, the base layer is sandwiched between the support layer and the antenna body, the ink is baked at an internal oven temperature between about 70° C. and about 75° C. for 30 minutes to 40 minutes to form the base layer.

15. The method as claimed in claim 14, wherein further comprising a step of printing a shield layer on the antenna body before the base body is formed on the support film, the painting is baked at an internal oven temperature of about 70° C. for 30 minutes to form the shield layer, the shield layer covers parts of the support film, the antenna body is sandwiched between the base layer and the shield layer.

16. An electronic device, comprising:
a main body; and
a housing mounted on the main body, the housing is as claimed in claim 1.

17. The electronic device of claim 16, wherein the main body includes a battery and a circuit board connected with the battery, the circuit board defines a terminal, the terminal can be electronically connected with at least one connecting member of the housing.
